(19) United States
(12) Patent Application Publication
(10) Pub. No.: US 2010/0202014 A1
(43) Pub. Date: Aug. 12, 2010

(54) PRINTING SYSTEM, PRINTING APPARATUS, AND METHOD OF CONTROLLING THE PRINTING APPARATUS

(75) Inventor: Yoichi Matsuyama, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/630,394

(22) Filed: Dec. 3, 2009

(30) Foreign Application Priority Data
Dec. 5, 2008 (JP) 2008-311140

(51) Int. Cl. G06F 3/12

(52) U.S. Cl. 358/1.15

(57) ABSTRACT

A printing system which is capable of reducing the possibility of the operation of a printing apparatus being stopped due to an error or a paper jam. The printing system includes a plurality of printing apparatuses and an information management server for managing the printing apparatuses. A printing apparatus stores processing result information on print data received from a host PC, and sends the processing result information to the information management server. The information management server manages the processing result information, and determines information for determining an alternate printing apparatus based on the processing result information, in response to an inquiry from the printing apparatus. Then, the information management server sends the information for determining an alternate printing apparatus to the printing apparatus. The printing apparatus sends the print data to the alternate printing apparatus, based on the information sent from the information management server.

### BACKGROUND OF THE INVENTION

1. Field of the Invention

The present invention relates to a printing system which enables a print job transmitted e.g. from a host PC to a printing apparatus to be transferred to another printing apparatus, a printing apparatus, and a method of controlling the printing apparatus.

2. Description of the Related Art

Conventionally, when some error (e.g. a PDL error) or a paper jam occurs during processing of a print job transmitted from a host PC to a printing apparatus, so-called alternate printing is performed by transferring a print job thereafter to another printing apparatus for printout.

As for general alternate printing, assuming that a printing apparatus failed in executing a print job due to occurrence of a trouble, such as an error or a paper jam, and has recovered from the failure, if the same print job as caused the failure is transmitted to the printing apparatus, the same failure will occur.

To solve this problem, there has been proposed a technique in which the frequency of occurrence of failure is recorded for each host PC that generates print jobs, and the priority of a print job from a host PC of which the frequency of failure of occurrence is high is lowered, and further the frequency of occurrence of failure is managed for each application with which print jobs are generated (see Japanese Patent Laid-Open Publication No. H11-24854).

According to the proposed technique, the priority of a print job from a host PC with a high frequency of occurrence of failure or a print job generated by an application with a high frequency of occurrence of failure is lowered, whereby a printing apparatus can postpone occurrence of a failure and process another print job.

However, although the technique disclosed in Japanese Patent Laid-Open Publication No. H11-24854 makes it possible to postpone occurrence of a failure in a printing apparatus, it is impossible to prevent the occurrence of the failure in the printing apparatus. Further, information on the frequency of failure occurrence does not suffice to predict occurrence of a failure. For example, even if the frequency of failure occurrence of a print job generated by an application is high, the print job may not cause a failure, depending on a command pattern or the like of PDL data forming the print job. On the other hand, even a print job generated by an application with a low frequency of failure occurrence may cause a failure depending on a command pattern of PDL data, the number of pages of the same, or the like.

### SUMMARY OF THE INVENTION

The present invention provides a printing system which is capable of reducing the possibility of the operation of a printing apparatus being stopped due to an error or a paper jam, a printing apparatus, and a method of controlling the printing apparatus.

In a first aspect of the present invention, there is provided a printing system including a plurality of printing apparatuses, and a server for managing the printing apparatuses, wherein the printing apparatus comprises a storing unit configured to store processing result information on print data, a notification unit configured to notify the processing result information to the server, an extraction unit configured to extract identification information from print data transmitted from an information processing apparatus, a determination unit configured to determine, based on the identification information and the processing result information, whether or not it is possible to normally print the print data transmitted from the information processing apparatus, an inquiry unit configured to be operable when the determination unit determines that it is not possible to normally print the print data, to make an inquiry of an alternate printing apparatus which is capable of normally printing the print data transmitted from the information processing apparatus, to the server, and a transmission unit configured to transmit the print data transmitted from the information processing apparatus to the alternate printing apparatus, based on information for identifying an alternate printing apparatus as a transfer destination, which is transmitted from the server in response to the inquiry made by the inquiry unit, and wherein the server comprises a management unit configured to manage the processing result information on the print data notified from the printing apparatus by the notification unit, a determining unit configured to determine the information for identifying an alternate printing apparatus as a transfer destination, based on the processing result information managed by the management unit, in response to the inquiry from the printing apparatus made by the inquiry unit, and a returning unit configured to return the information for identifying an alternate printing apparatus as a transfer destination, which is determined by the determining unit, to the printing apparatus that made the inquiry.

In a second aspect of the present invention, there is provided a printing apparatus which is capable of communicating with an information processing apparatus, at least one other printing apparatus, and a server for managing a plurality of printing apparatuses, comprising a storing unit configured to store processing result information on print data, a notification unit configured to notify the processing result information to the server, an extraction unit configured to extract identification information from print data transmitted from the information processing apparatus, a determination unit configured to determine, based on the identification information and the processing result information stored in the storing unit, whether or not it is possible to normally print the print data transmitted from the information processing apparatus, an inquiry unit configured to be operable when the determination unit determines that it is not possible to normally print the print data, to make an inquiry of an alternate printing apparatus which is capable of normally printing the print data transmitted from the information processing apparatus, to the server, and a transmission unit configured to transmit the print data transmitted from the information processing apparatus to the alternate printing apparatus, based on information for identifying an alternate printing apparatus, which is transmitted from the server in response to the inquiry made by the inquiry unit.

In a third aspect of the present invention, there is provided a method of controlling a printing apparatus which is capable of communicating with an information processing apparatus, at least one other printing apparatus, and a server for managing a plurality of printing apparatuses, comprising storing processing result information on print data in a storing unit, notifying the processing result information to the server, extracting identification information from print data transmitted from the information processing apparatus, determining, based on the identification information and the processing result information stored in the storing unit, whether or not it is possible to normally print the print data transmitted from the information processing apparatus, making an inquiry of an alternate printing apparatus which is capable of normally printing the print data transmitted from the information processing apparatus, to the server, when the determining determines that it is not possible to normally print the print data, and transmitting the print data transmitted from the information processing apparatus to the alternate printing apparatus, based on the information for identifying an alternate printing apparatus, which is transmitted from the server in response to the inquiry.

According to the present invention, it is possible to reduce the possibility of a printing apparatus being stopped due to an error or a paper jam, to thereby improve operational efficiency.

Further features of the present invention will become apparent from the following description of exemplary embodiments (with reference to the attached drawings).

### BRIEF DESCRIPTION OF THE DRAWINGS

FIG. 1 is a block diagram of a printing system according to a first embodiment of the present invention.

FIG. 2 is a block diagram showing the system configuration of each of an information management server and a host PC.

FIG. 3 is a block diagram showing the system configuration of a printing apparatus.

FIG. 4A is a diagram of an example of an information table managed by the printing apparatus.

FIG. 4B is a diagram of an example of an information table managed by the information management server.

FIG. 5 is a flowchart of a printing process executed by the printing apparatus.

FIG. 6 is a continuation of FIG. 5.

FIG. 7 is a view of an example of a preference designation page.

FIG. 8 is a view of an example of an alternate printing apparatus designation dialog.

FIG. 9 is a flowchart of an alternate printing management process executed by the information management server.

FIG. 10 is a continuation of FIG. 9.

FIGS. 11A to 11D are tables useful in explaining generation of an alternate printing apparatus list.

FIG. 12 is a flowchart of a print data transmission process executed in a printing system according to a second embodiment of the present invention so as to transmit PDL data from a host PC to a printing apparatus.

FIG. 13 is a continuation of FIG. 12.

### DETAILED DESCRIPTION OF THE EMBODIMENTS

The present invention will now be described in detail below with reference to the accompanying drawings showing embodiments thereof.

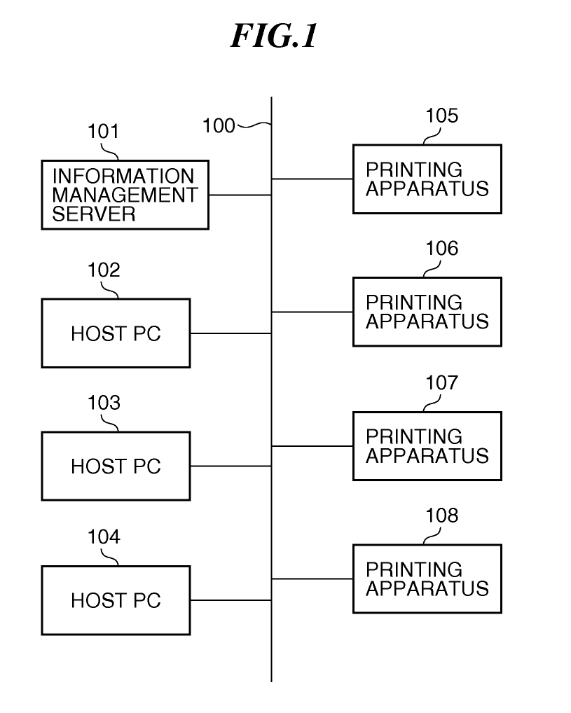

FIG. 1 is a block diagram of a printing system according to a first embodiment of the present invention.

As shown in FIG. 1, the printing system of the present embodiment is comprised of an information management server 101, a plurality of host PCs (information processing apparatuses) 102, 103, and 104, and a plurality of printing apparatuses 105, 106, 107, and 108, which are communicably interconnected via a network 100.

The information management server 101 manages results of processing of print jobs by each of the printing apparatuses 105, 106, 107, and 108.

Each of the host PCs 102, 103, and 104 transfers PDL data generated by a printer driver thereof based on data generated by an application operating on the host PC to a printing apparatus via the network 100.

Each of the printing apparatuses 105, 106, 107, and 108 generates a printout by processing PDL data transferred from a host PC.

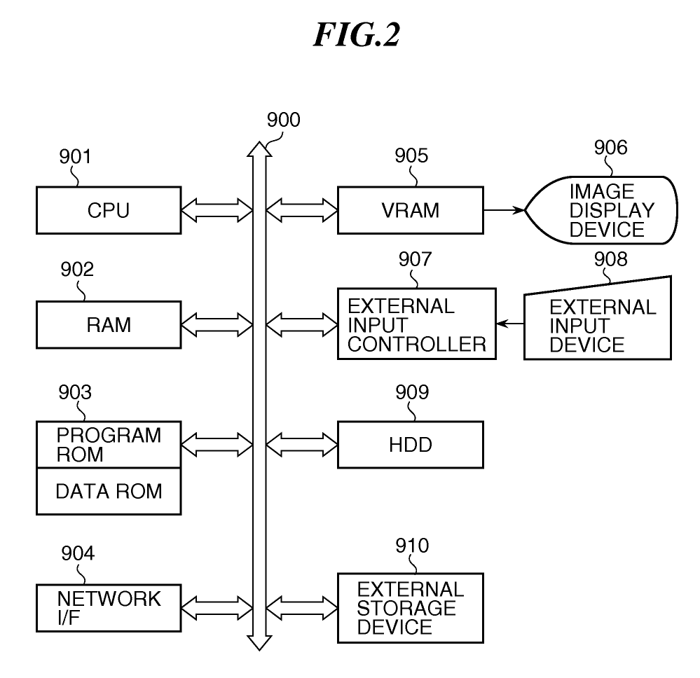

FIG. 2 is a block diagram of the system configuration of the information management server 101. The host PCs 102, 103, and 104 are identical in system configuration to the information management server 101, and therefore description thereof is omitted.

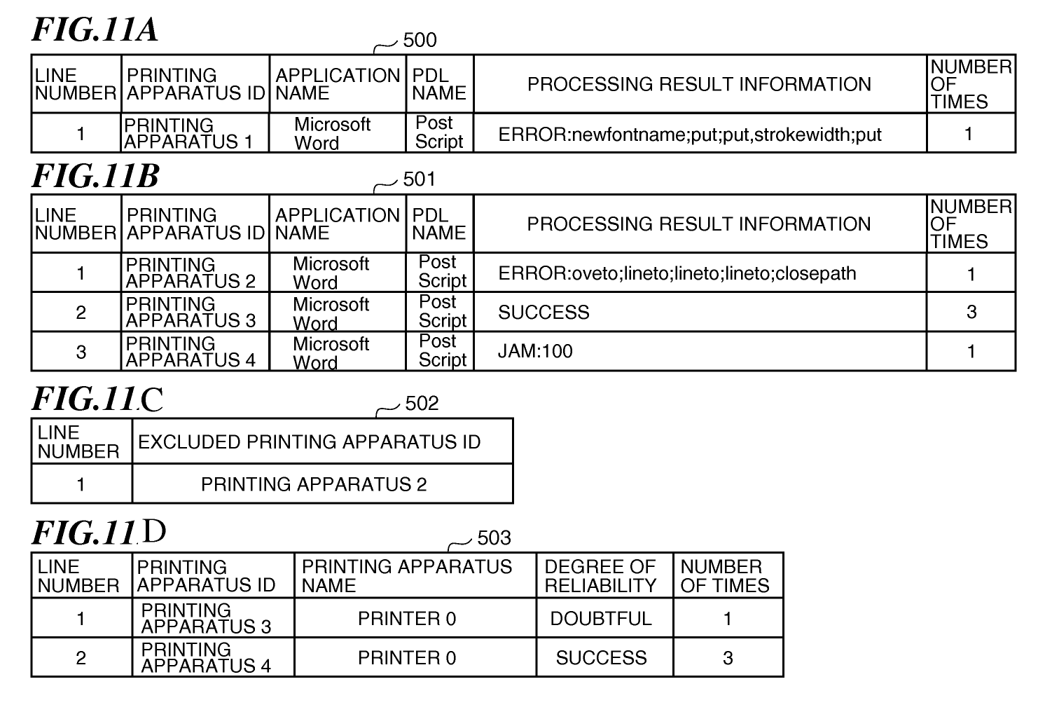

As shown in FIG. 2, a CPU 901 controls the overall operation of the apparatus. A RAM 902 not only functions as a main memory of the CPU 901, but also serves as a work area and a temporary save area for a control program. Further, the RAM 902 temporarily stores tables 500 to 503 (see FIGS. 11A to 11D) for use in generating an alternate printing apparatus list, described hereinafter.

A ROM 903 stores processing programs and data for operating the CPU 901. More specifically, the ROM 903 includes a program ROM for storing a system program and control programs, and a data ROM for storing information and the like necessary for operating the system.

A network interface (I/F) 904 is connected to the network 100 to perform data control and diagnosis for data transmission and reception. In a VRAM 905, an image is loaded which is to be displayed on a screen of an image display device 906 for displaying an operational status of the system, and the VRAM 905 is used for control of the display. An external input controller 907 controls an input signal input from an external input device 908, such as a keyboard or a pointing device (mouse or the like).

An HDD 909 is used to temporarily store print data and store an information table 201, referred to hereinafter. The information table 201 stored in the HDD 909 is loaded in the RAM 902, for temporary use.

An external storage device 910 is a removable disk drive, such as a flexible disk, and is used e.g. for reading out an application program from a storage medium. An I/O bus 900 serves as an address bus, a data bus, and a control bus, for connection between the units.

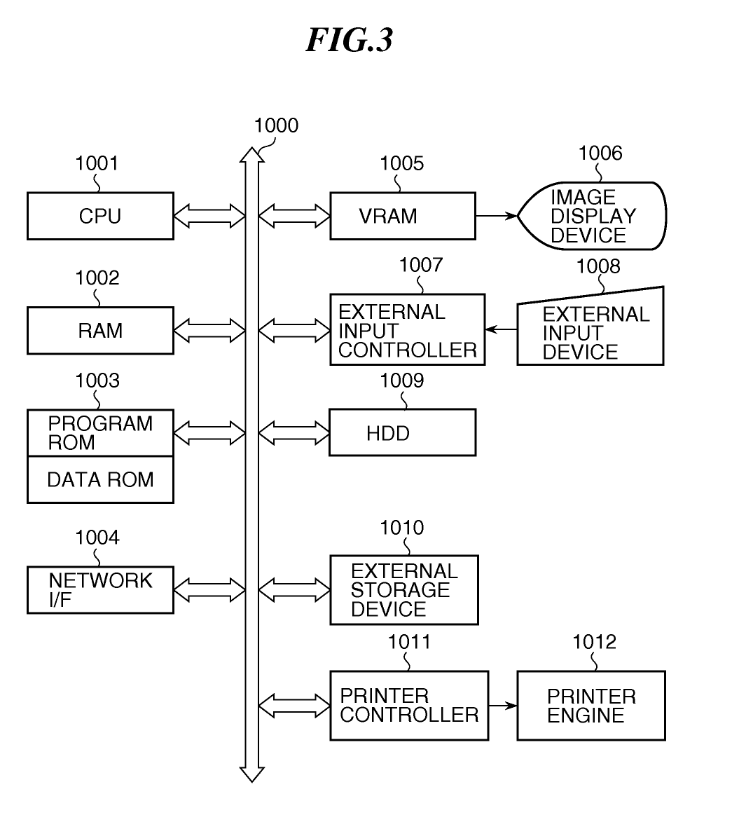

FIG. 3 is a block diagram showing the system configuration of each of the printing apparatuses 105, 106, 107, and 108.

As shown in FIG. 3, a CPU 1001 controls the overall operation of the apparatus. A RAM 1002 not only functions as a main memory of the CPU 1001, but also serves as a work area and a temporary save area for a control program.

A ROM 1003 stores processing programs and data for operating the CPU 1001. More specifically, the ROM 1003 includes a program ROM for storing a system program and control programs, and a data ROM for storing information and the like necessary for operating the system.

A network interface (I/F) 1004 is connected to the network 100 to perform data control and diagnosis for data transmission and reception. In a VRAM 1005, an image is loaded which is to be displayed on a screen of an image display device 1006 for displaying an operational status of the system, and the VRAM 1005 is used for control of the display. An external input controller 1007 controls input signals input from an external input device 1008, such as a keyboard or a pointing device (mouse or the like).

An HDD 1009 stores PDL data transferred from a host PC and an information table 200. An external storage device 1010 is a removable disk drive, such as a flexible disk, and is used to read out an application program from a storage medium or back up the information table 200 in a storage medium.

A printer controller 1011 controls a printer engine 1012 and images to be output. The printer engine 1012 prints print data sent from the printer controller 1011 on a sheet according to an instruction from the printer controller 1011. An I/O bus 1000 serves as an address bus, a data bus, and a control bus, for connection between the units.

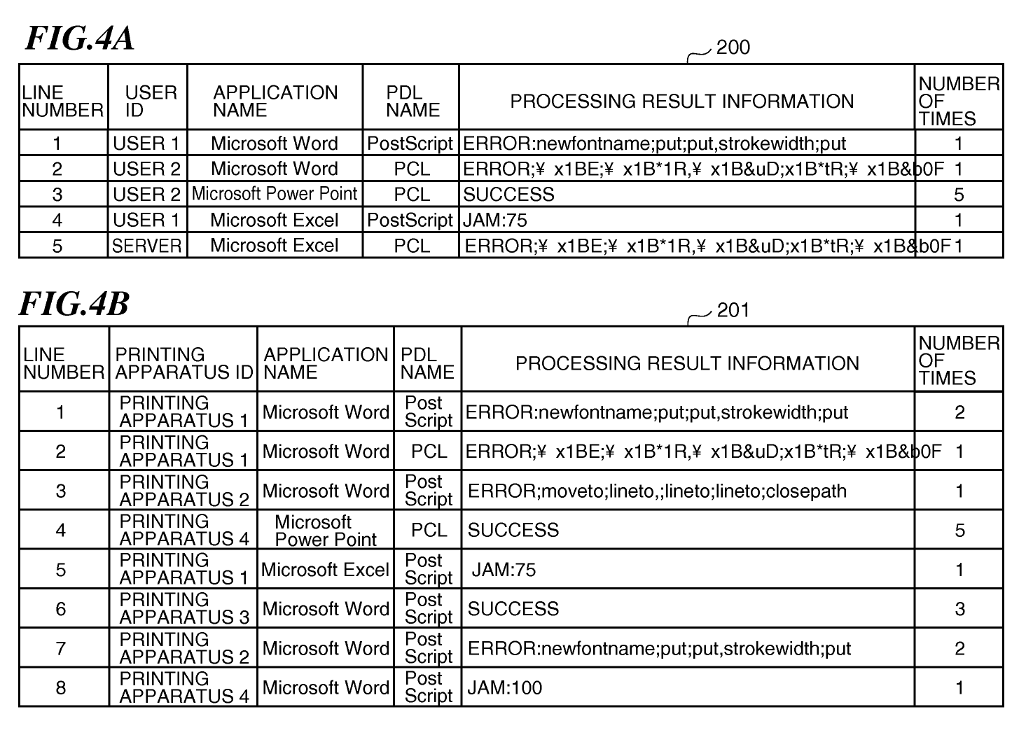

FIG. 4A is a diagram of an example of the information table 200 managed by the printing apparatus 105, while FIG. 4B is a diagram of an example of the information table 201 managed by the information management server 101.

The information table 200 managed by the printing apparatus 105 is stored in the HDD 1009, and is read into the RAM 1002 in response to an instruction from the CPU 1001, for reference. The information table 201 managed by the information management server 101 is stored in the HDD 909, and is read into the RAM 902 in response to an instruction from the CPU 901, for reference. The information table 200, of which one example used by the printing apparatus 105 is shown in FIG. 4A, is stored in each of the printing apparatuses 105 to 108, and the information table 201 shown in FIG. 4B collectively contains all information items contained in the information tables 200 stored in the respective printing apparatuses 105 to 108.

The information table 200 managed by the printing apparatus 105 stores the user IDs of respective users who ever issued PDL data each as a print job, and the application names of respective applications each of which ever generated document data which was converted to PDL data. Further, the information table 200 stores the names of respective PDLs for forming PDL data, processing result information on PDL data, and the number of times of processing thereof.

Referring to FIG. 4A, a line, such as one assigned line number 5, which has an entry of “Server” in an associated box of a user ID column, represents processing result information on PDL data which caused an error or a paper jam in all of the printing apparatuses managed by the information management server 101. This line is added in response to a notification from the information management server 101. Processing for adding a line will be described hereinafter.

Each of the tables 200 and 201 shown in FIGS. 4A and 4B may include an item of information (e.g. an IP address) for identifying a host PC that issued a print job. Further, the item of an application name and that of a PDL name may include information for identifying a version of the application and information for identifying a version of the PDL, respectively.

The processing result information on PDL data is formed by a processing result status and accompanying information. The processing result status has an entry selected from “SUCCESS:” indicative of success of processing, “ERROR:” indicative of occurrence of an error, and “JAM:” indicative of occurrence of a paper jam.

The processing result status “SUCCESS:” has no accompanying information. The accompanying information of the processing result status “ERROR:” retrospectively describes a predetermined number of PDL commands preceding a PDL command that caused an error in a row. In the present embodiment, the predetermined number is set to 5, and arguments of the respective commands are ignored. The commands are separated from each other by a semicolon “;”. The accompanying information of the processing result status “JAM:” describes the total number of pages of PDL data that caused a paper jam.

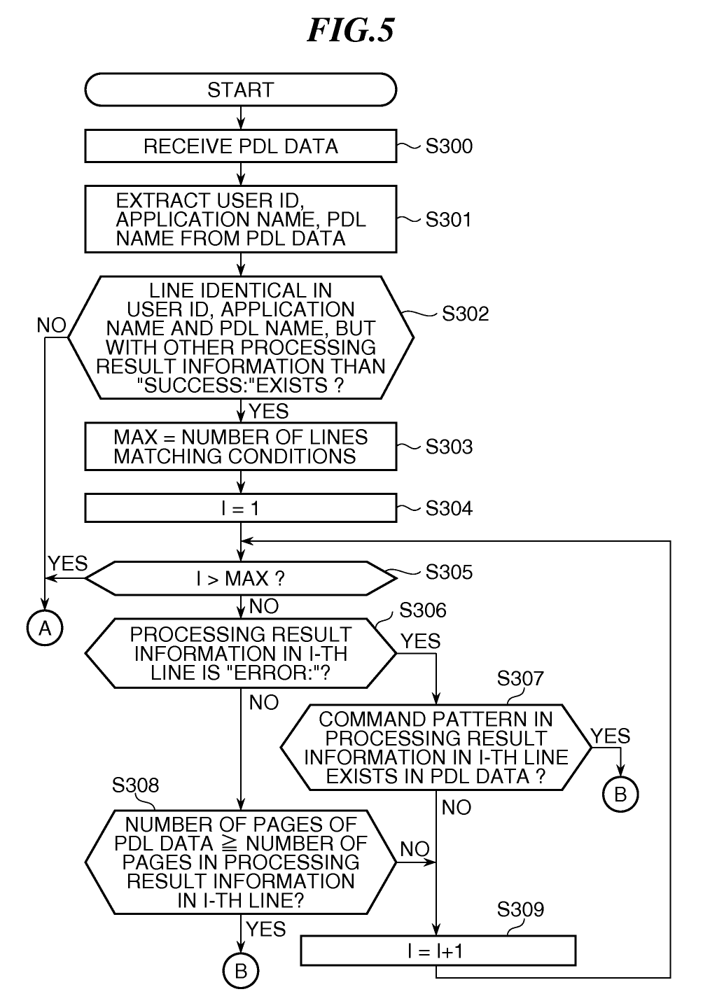

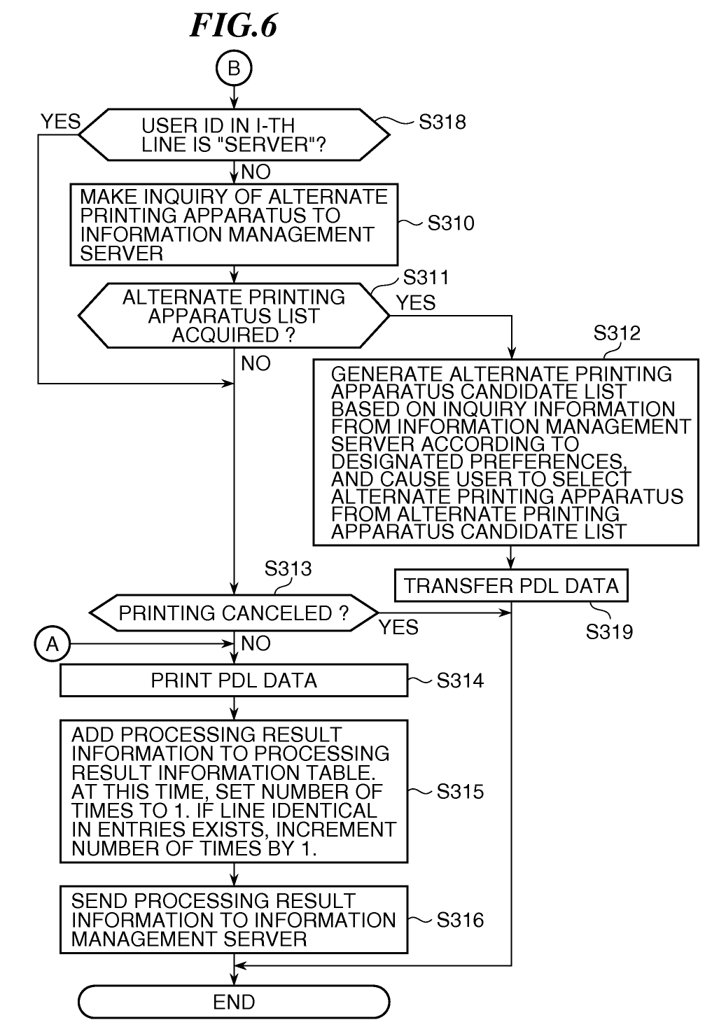

Next, a printing process executed by the printing apparatus 105 will be described with reference to FIGS. 5 and 6. The printing process shown in FIGS. 5 and 6 is executed by the CPU 1001 after a control program stored in the ROM 1003 or the HDD 1009 of the printing apparatus 105 is loaded into the RAM 1002.

Referring to FIG. 5, in a step S300, the CPU 1001 receives PDL data generated in one of the host PCs 102, 103, and 104 via the network 100, and the process proceeds to a step S301.

In the step S301, the CPU 1001 analyzes the received PDL data and extracts the user ID of the host PC that generated the PDL data, the application name of an application used for generating document data which was converted to the PDL data, and the PDL name (identification information) of the PDL data, and then the process proceeds to a step S302.

In the step S302, the CPU 1001 determines whether or not the information table 200 contains a line which has the same entries of the user ID, application name, and PDL name as those extracted in the step S301, and an entry of the processing result status other than “SUCCESS:”. If the information table 200 contains such a line, the process proceeds to a step S303, whereas if not, the process proceeds to a step S314 in FIG. 6.

In the step S314, the CPU 1001 prints the received PDL data, and then the process proceeds to a step S315. To perform printing in the step S314, the CPU 1001 executes a PDL processing program stored in the ROM 1003, generates an image by processing of the PDL data in the RAM 1002, and sends the image to the printer engine 1012 via the printer controller 1011.

In the step S315, the CPU 1001 adds a result of printing processing of the PDL data to the information table 200. At this time, when the information table 200 does not contain a line having a user ID, an application name, a PDL name, and processing result information all identical to those of the present PDL data, the CPU 1001 adds a new line in which the number of times of processing is set to 1 to the information table 200 for registration. When the processing result status is “SUCCESS:”, a line having the same user ID, application name, and PDL name as those associated with the present PDL data can already exist. In this case, the CPU 1001 increments the number of times of processing of the associated line by 1, and the process proceeds to a step S316.

In the step S316, the CPU 1001 sends the information added to the information table 200 in the step S315 to the information management server 101, followed by terminating the present process.

(PDL Data Error/Jam Prediction (Analysis Process) Executed By Printing Apparatus, Based On Processing Result Information)

Referring again to FIG. 5, in the step S303, the CPU 1001 sets the number of lines matching the above-mentioned conditions in the step S302 to a variable MAX, and the process proceeds to a step S304.

In the step S304, the CPU 1001 initializes a counter variable I to 1, and then the process proceeds to a step S305.

In the step S305, the CPU 1001 determines whether or not the value of the counter variable I exceeds that of the variable MAX. If the value of the counter variable I is more than that of the variable MAX, the process proceeds to the step S314 in FIG. 6, whereas if the value of the counter variable I is not more than that of the variable MAX as in the case of immediately after the initialization of the counter variable I, the process proceeds to a step S306.

In the step S306, the CPU 1001 determines whether or not the processing result status in an I-th line of all the lines matching the above-mentioned conditions in the step S302 of the information table 200 is “ERROR:”. If the processing result status is not “ERROR:”, the process proceeds to a step S308, whereas if the processing result status is “ERROR:”, the process proceeds to a step S307.

In the step S307, the CPU 1001 determines whether or not the received PDL data contains a command pattern described in the processing result information in the I-th line of all the lines matching the above-mentioned conditions in the step S302 of the information table 200. If the received PDL data does not contain the command pattern, the process proceeds to a step S309, whereas if the received PDL contains the command pattern, the process proceeds to a step S318 in FIG. 6.

In the step S309, the CPU 1001 increments the value of the counter variable I by 1, and then the process returns to the step S305.

In the step S308, the CPU 1001 determines whether the total number of pages of the received PDL data is not less than an entry of the number of pages in the processing result information in the I-th line of all the lines matching the above-mentioned conditions in the step S302 of the information table 200. If the total number of pages of the PDL data is less than the entry in the processing result information, the process proceeds to the step S309, whereas if the same is not less than the entry in the processing result information, the process proceeds to the step S318.

Referring to FIG. 6, in the step S318, the CPU 1001 determines whether or not a user ID entered in the I-th line of all the lines matching the above-mentioned conditions in the step S302 of the information table 200 is “Server”. If the user ID is “Server”, it means that the associated PDL data has caused an error or a paper jam in all of the printing apparatuses managed by the information management server 101. Therefore, if the CPU 1001 determines that the user ID is “Server”, the process proceeds to a step S313, whereas if not, the process proceeds to a step S310.

In the step S313, the CPU 1001 determines whether or not the printing process has been canceled e.g. by a user operation on the host PC. If the printing process has been canceled, the present process is terminated, whereas if not, the process proceeds to the step S314.

In the step S310, the CPU 1001 makes an inquiry of an alternate printing apparatus as a transfer destination to the information management server 101, and the process proceeds to a step S311. To make an inquiry of an alternate printing apparatus in the step S310, the CPU 1001 sends contents of the items of a line matching the conditions in the step S302 and the condition in the step S307 or 5308 of the information table 200 except the line number and the printing apparatus ID of the printing apparatus 105, to the information management server 101.

(Selection of Alternate Printing Apparatus)

In the step S311, the CPU 1001 determines whether or not a transfer-destination alternate printing apparatus list 503 (see FIG. 11D), described hereinafter, has been acquired. If the alternate printing apparatus list 503 has been acquired, the process proceeds to a step S312, whereas if not, the process proceeds to the step S313. It should be noted that if it is determined in the step S311 that the alternate printing apparatus list 503 has not been acquired, i.e. if no alternate printing apparatus exists, the CPU 1001 may cause the image display device 1006 of the printing apparatus 105 or that of the host PC (102, 103, or 104) having transmitted the PDL data to display a warning screen indicating that no alternate printing apparatus exists.

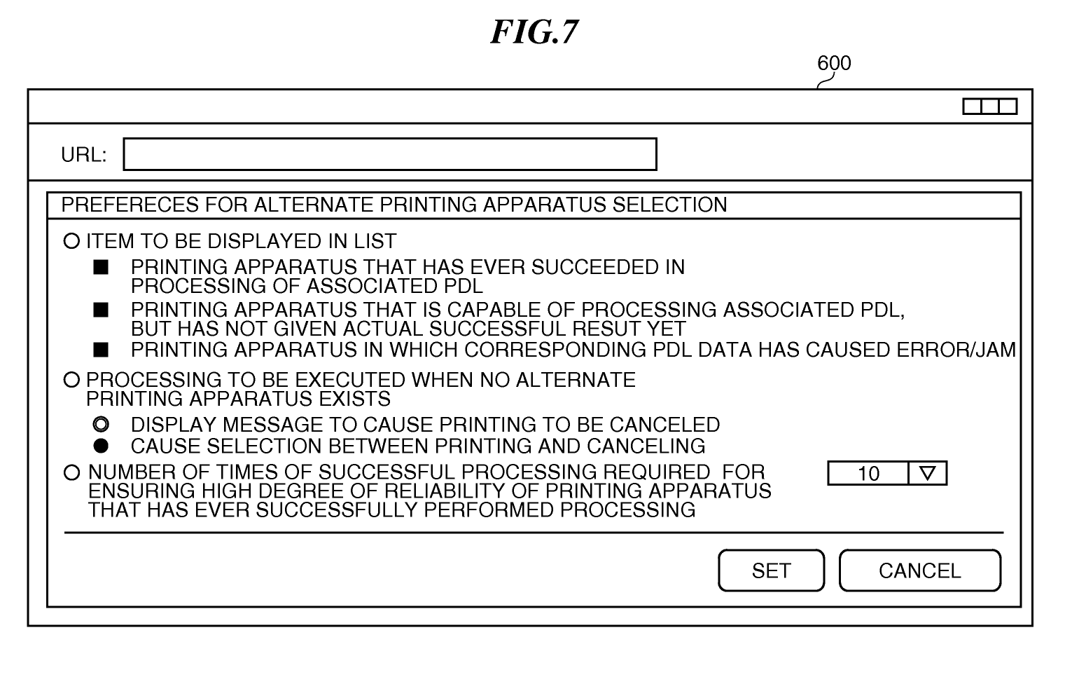

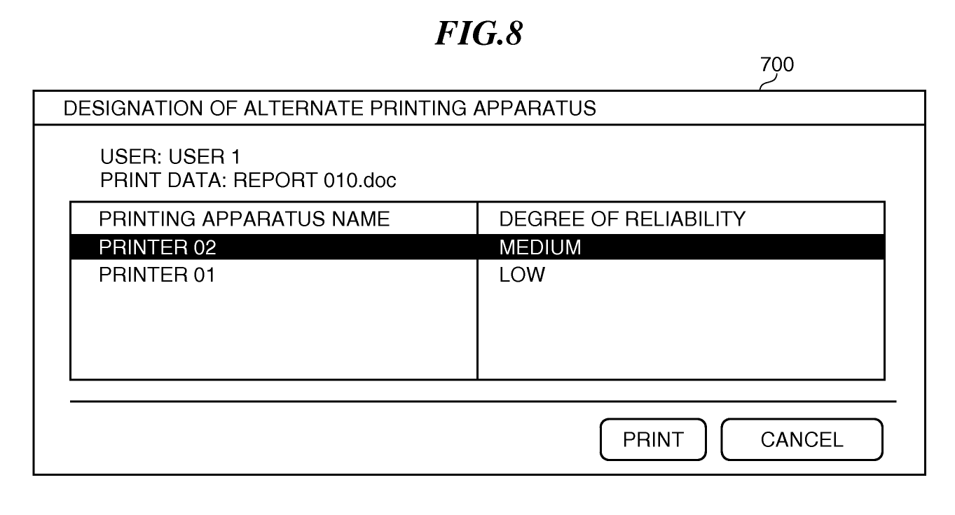

In the step S312, the CPU 1001 sends a display instruction for displaying an alternate printing apparatus designation dialog (selecting screen) 700 shown in FIG. 8 to the host PC according to preferences designated in a preference designation page 600 (see FIG. 7) displayed on a Web browser of the host PC.

The preference designation page 600 is displayed on the Web browser of the host PC 102, 103, or 104 e.g. when an administrator of a printing apparatus accesses a Web-based management screen of the printing apparatus. Further, preferences designated e.g. by the administrator of the printing apparatus on the preference designation page 600 are stored in the HDD 1009 of the printing apparatus.

On the preference designation page 600, there are designated respective definitions of printing apparatuses to be displayed as alternate printing apparatus candidates in the alternate printing apparatus designation dialog 700, processing to be executed when there is no alternate printing apparatus candidate, and a number of times of successful processing required for ensuring a “HIGH” degree of reliability of a printing apparatus that ever successfully performed processing of PDL data. In the illustrated example, designation performed on the preference designation page 600 is as follows: All items of definitions of alternate printing apparatus candidates to be displayed are selected; “cause selection between printing and canceling” is selected as processing to be executed when there is no alternate printing apparatus candidate; and “10” is designated as the number of times of successful processing required for ensuring the “HIGH” degree of reliability.

The alternate printing apparatus designation dialog 700 illustrated in FIG. 8 shows an example of a list of alternate printing apparatuses displayed based on the items designated on the preference designation page 600 and the alternate printing apparatus list 503. The alternate printing apparatus designation dialog 700 is displayed on the image display device 906 of a host PC having issued a print job, when a display instruction is given to the host PC by the printing apparatus 105 via the network 100.

In the alternate printing apparatus list 503 in FIG. 11D, referred to hereinafter, a degree of reliability associated with Printing Apparatus 4 (corresponding to the printing apparatus 108 in FIG. 1) of line number 2 is “SUCCESS”, but the number of times of successful processing of the same is “3”, which means that the number of times of successful processing in the past has not reached the number ensuring the “HIGH” degree of reliability. For this reason, in the alternate printing apparatus designation dialog 700 shown in FIG. 8, the degree of reliability of Printer 02, which corresponds to Printing Apparatus 4 of line number 2 in FIG. 11D, is displayed as “MEDIUM”. When the degree of reliability in the alternate printing apparatus list 503 is “UNKNOWN” or “DOUBTFUL”, the degree of reliability in the alternate printing apparatus designation dialog 700 is displayed as “LOW”.

The user of the host PC selects an alternate printing apparatus from the list in the alternate printing apparatus designation dialog 700 using the external input device 908, such as a pointing device, and presses a print button to thereby enable the selected alternate printing apparatus to normally print PDL data. The user can also cancel printing by pressing a cancel button. When the user selects an alternate printing apparatus from the list in the alternate printing apparatus designation dialog 700 and presses the print button, the host PC sends information on the selection to the printing apparatus 105 via the network 100.

Referring again to FIG. 6, upon reception of the selection information from the host PC in a step S319, the CPU 1001 transfers the PDL data to the alternate printing apparatus selected by the user, followed by terminating the present process.

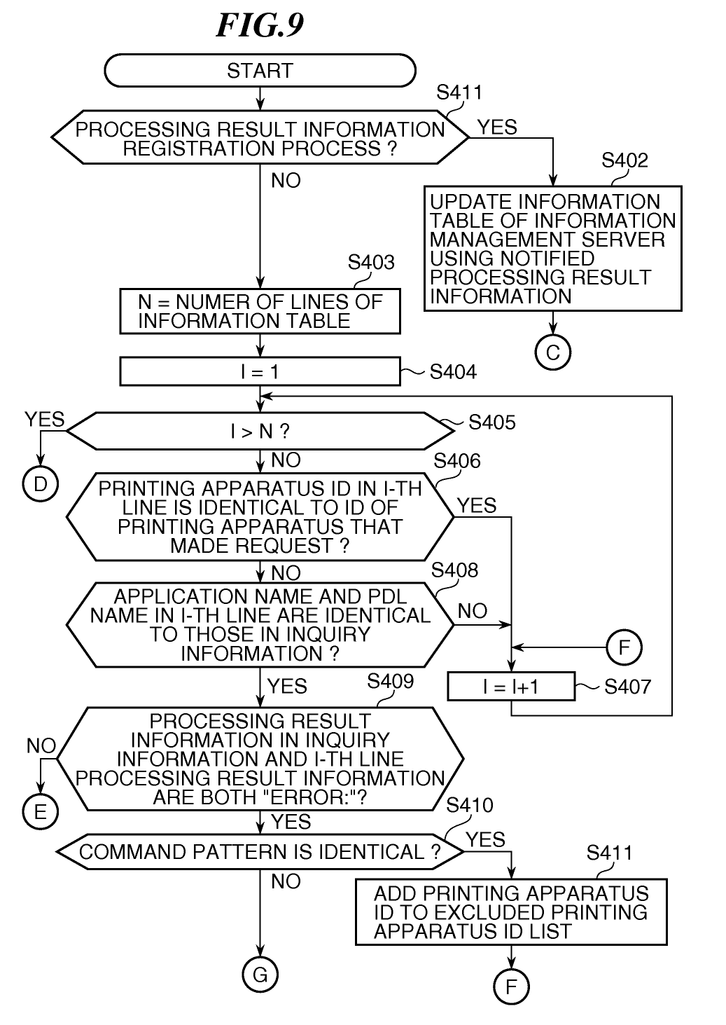

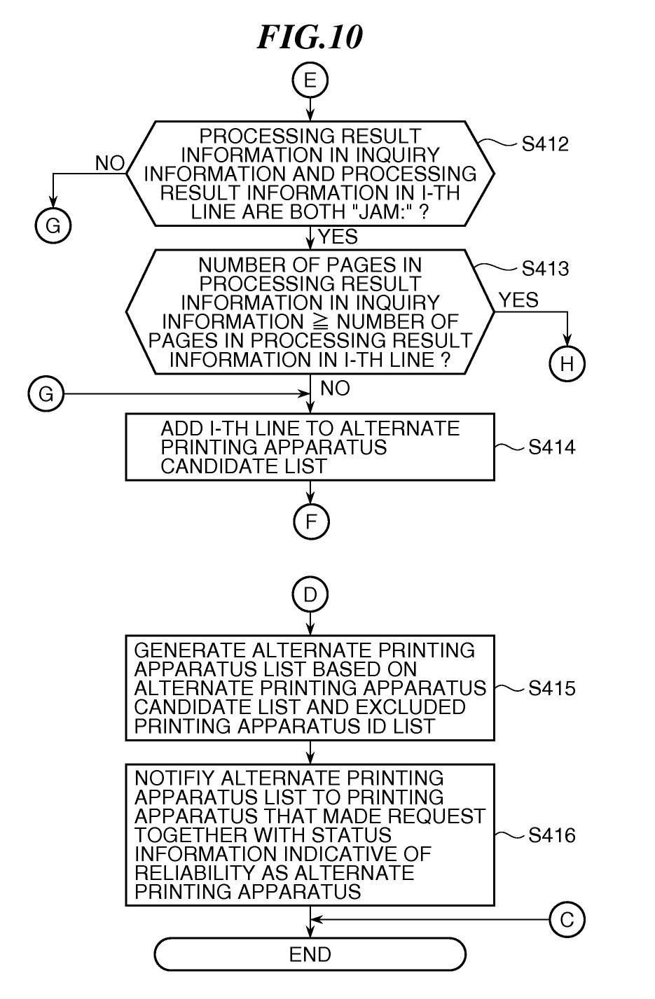

Next, an alternate printing management process executed by the information management server 101 will be described with reference to FIGS. 9 and 10. The alternate printing management process shown in FIGS. 9 and 10 is executed by the CPU 901 after a control program stored in the ROM 903, the HDD 909 or the like of the information management server 101 is loaded in the RAM 902.

As shown in FIG. 9, upon reception of a request from the printing apparatus 105, the CPU 901 determines in a step S401 whether or not the request is for registration of processing result information. If the request is not for registration of processing result information, the process proceeds to a step S403, whereas if the request is for registration of processing result information, the process proceeds to a step S402.

In the step S402, the CPU 901 updates the information table 201 (see FIG. 4B) stored in the HDD 909 by adding processing result information sent from the printing apparatus 105, followed by terminating the present process.

In the step S402, when a line which is identical to an existing line in respect of the application name, the PDL name, and the processing result information, i.e. the items other than the printing apparatus ID and the number of times of processing, and has an entry of the processing result status other than “SUCCESS:” is added to the information table 201, and the item of “number of times” is updated. Further, when a line matching these conditions is added, the number of times of processing in the existing line is incremented by 1, and the number of times of processing in the added line is also set to the incremented number.

In the example of the information table 201 shown in FIG. 4B, the number of times of processing in the line assigned line number 1 is equal to 1 before addition of a line assigned line number 7. Then, when the line of line number 7 identical to that of line number 1 in the items other than the printing apparatus ID and the number of times of processing is added, the number of times in the line having line number 1 is incremented by 1 to be set to 2, and the number of times in the added line having line number 7 is also set to 2.

If the number of times of processing in a line with an entry of the processing result status other than “SUCCESS:” becomes equal to the number of printing apparatuses managed by the information management server 101, it means that a command pattern or the number of pages in the processing result information described in the line resulted in an error or a paper jam in all of the printing apparatuses.

On the other hand, in the step S403, the CPU 901 sets a variable N to the number of lines of the information table 201, and the process proceeds to a step S404.

In the step S404, the CPU 901 initializes its counter variable I to 1, and the process proceeds to a step S405.

In the step S405, the CPU 901 determines whether or not the counter variable I exceeds the variable N. If the counter variable I is more than the variable N, the process proceeds to a step S415 in FIG. 10, whereas if the counter variable I is not more than the variable N, the process proceeds to a step S406.

In the step S406, the CPU 901 determines whether or not the printing apparatus ID in the I-th line of the information table 201 is identical to that of the printing apparatus making an inquiry of an alternate printing apparatus (see the step S310 in FIG. 6). If the printing apparatus ID in the I-th line is identical to that of the printing apparatus making an inquiry of an alternate printing apparatus, the process proceeds to a step S407, whereas if not, the process proceeds to a step S408.

In the step S407, the CPU 901 increments the value of the counter variable I by 1, and the process returns to the step S405.

In the step S408, the CPU 901 determines whether or not an application name and a PDL name contained in inquiry information from the printing apparatus 105 are identical to those in the I-th line. If at least one of the application name and the PDL name is different from the corresponding one in the I-th line, the process proceeds to the step S407. In the step S407, the CPU 901 increments the value of the counter variable I by 1, and the process returns to the step S405. If the application name and the PDL name contained in the inquiry information are both identical to those in the I-th line, the process proceeds to a step S409.

In the step S409, the CPU 901 determines whether or not the processing result status in processing result information contained in the inquiry information from the printing apparatus 105 and the processing result status in the processing result information in the I-th line of the information table 201 are both “ERROR:”. If the two are not both “ERROR:”, the process proceeds to a step S412 in FIG. 10, whereas if the two are both “ERROR:”, the process proceeds to a step S410.

In the step S410, the CPU 901 determines whether or not the command pattern of the processing result information contained in the inquiry information from the printing apparatus 105 and that of the processing result information in the I-th line of the information table 201 are identical to each other. If the two command patterns are identical to each other, the process proceeds to a step S411, whereas if the two command patterns are different from each other, the process proceeds to a step S414 in FIG. 10.

In the step S411, the CPU 901 adds the printing apparatus ID in the I-th line to an excluded printing apparatus ID list, and the process proceeds to the step S407. In the step S407, the CPU 901 increments the value of the counter variable I by 1, and the process returns to the step S405. The excluded printing apparatus ID list, described in detail hereinafter, stores the IDs of printing apparatuses unsuitable for an alternate printing apparatus.

In the step S412 in FIG. 10, the CPU 901 determines whether or not the processing result status in the processing result information contained in the inquiry information from the printing apparatus 105 and the processing result status in the I-th line of the Information table 201 are both “JAM:”. If the two are not both “JAM:”, the process proceeds to the step S414, whereas if the two are both “JAM:”, the process proceeds to a step S413.

In the step S413, the CPU 901 compares the number of pages in the processing result information contained in the inquiry information from the printing apparatus 105 with the number of pages in the processing result information in the I-th line of the information table 201. If the number of pages in the processing result information contained in the inquiry information is not less than that in the processing result information in the I-th line, the process proceeds to the step S411.

In the step S411, the CPU 901 adds the printing apparatus ID in the I-th line to the excluded printing apparatus ID list, and the process proceeds to the step S407. In the step S407, the CPU 901 increments the value of the counter variable I by 1, and the process returns to the step S405. The reason why the printing apparatus ID in the I-th line is added to the excluded printing apparatus ID list is that the printing apparatus associated with the I-th line has a high possibility that a paper jam is caused with a smaller number of pages than the number of pages of the PDL data to be subjected to printing processing.

On the other hand, if the CPU 901 determines in the step S413 that the number of pages in the processing result information contained in the inquiry information is less than that in the processing result information in the I-th line of the information table 201, the process proceeds to the step S414.

In the step S414, the CPU 901 adds the I-th line of the information table 201 to an alternate printing apparatus candidate list. The alternate printing apparatus candidate list stores information on printing apparatuses as candidates for alternate printing apparatuses. After the I-th line of the information table 201 is added to the alternate printing apparatus candidate list, the process proceeds to the step S407 in FIG. 9, and the CPU 901 increments the value of the counter variable I by 1, and the process returns to the step S405.

If it is determined in the step S405 that the value of the counter variable I exceeds the variable N, it is determined that processing has been completed on all lines of the information table 201, and hence the CPU 901 proceeds to the step S415.

In the step S415, the CPU 901 generates an alternate printing apparatus list, referred to hereinafter, based on the alternate printing apparatus candidate list and the excluded printing apparatus ID list, and the process proceeds to a step S416.

In the step S416, the CPU 901 sends the alternate printing apparatus list generated in the step S415 back to the printing apparatus 105 making the requesting, via the network 100.

(Generation of Alternate Printing Apparatus List)

Next, a method of generating the alternate printing apparatus list in the step S415 in FIG. 10 will be described with reference to FIGS. 11A to 11D. Here, a case of generating the alternate printing apparatus list according to the information of the line having line number 1 in the information table 200 stored in the printing apparatus 105 will be taken as an example.

FIGS. 11A to 11D are tables useful in explaining generation of the alternate printing apparatus list. These tables 500 to 503 are generated in the RAM 902 by the CPU 901 of the information management server 101.

The table 500 corresponds to the information of the line having line number 1 in the information table 200 stored in the printing apparatus 105, and the information in this table 500 is sent from the printing apparatus 105 to the information management server 101 together with an alternate printing apparatus request. The information set forth in the table 500 and the alternate printing apparatus request forms alternate printing apparatus request information.

The CPU 901 of the information management server 101 generates the alternate printing apparatus candidate list 501 and the excluded printing apparatus ID list 502 from its own information table 201 by executing the alternate printing management process shown in FIGS. 9 and 10.

The line having line number 7 in the information table 201 in FIG. 4B matches a portion of the alternate printing apparatus request information corresponding to the table 500, and therefore Printing Apparatus 2 (corresponding to the printing apparatus 106 in FIG. 1) is added to the excluded printing apparatus ID list 502.

Added to the alternate printing apparatus candidate list 501 are three lines of the information table 201, each of which has a printing apparatus ID other than that of Printing Apparatus 1 and the same application name and PDL name as contained in the table 500 in the alternate printing apparatus request information, but are different in processing result information.

The line having line number 1 in the alternate printing apparatus candidate list 501 contains the same printing apparatus ID as that contained in the excluded printing apparatus ID list 502. Therefore, the line having line number 1 is excluded, and lines having line numbers 2 and 3 form the information of alternate printing apparatuses.

The CPU 901 of the information management server 101 generates the alternate printing apparatus list 503 from this information of alternate printing apparatuses, and sends the generated list 503 to the printing apparatus 105 making the request.

Each line of the alternate printing apparatus list 503 describes a printing apparatus name corresponding to a printing apparatus ID, a degree of reliability derived from information in the alternate printing apparatus candidate list 501, and a number of times of processing. Reliability is classified into three degrees “SUCCESS”, “UNKNOWN”, and “DOUBTFUL”.

The degree “SUCCESS” corresponds to a line with the processing result information “SUCCESS” in the alternate printing apparatus candidate list 501. The degree “UNKNOWN” is assigned to a printing apparatus described in a line of the table 500 of the alternate printing apparatus request information, which does not match any line in the information table 201 in respect of the application name and the PDL name. The illustrated example has no printing apparatus to which the degree “UNKNOWN” is assigned. The degree “DOUBTFUL” indicates a case other than the cases of the degree “SUCCESS” and the degree “UNKNOWN”. The degree “DOUBTFUL” is assigned to a printing apparatus described in a line in the table 500 of the alternate printing apparatus request information which matches a line in the information table 201 in respect of the application name and the PDL name but not in respect of processing result information.

As described above, according to the present embodiment, before PDL data is processed by a printing apparatus, it is determined whether or not the PDL data has a high possibility of causing an error or a paper jam. If there is a high possibility that the PDL data might cause an error or a paper jam, the PDL data is transferred to another printing apparatus having a lower possibility of occurrence of an error or a paper jam, and is processed by the same. This makes it possible to reduce the possibility of the operation of each printing apparatus being stopped due to an error or a paper jam, to thereby enhance operational efficiency.

Further, in the present embodiment, the alternate printing apparatus designation dialog 700, shown in FIG. 8, is displayed on a host PC, thereby prompting the user to select an alternate printing apparatus or cancel printing. This makes it possible to carry out printing using an alternate printing apparatus that meets user's demand. Further, the user is given a chance to cancel printing, which makes it possible to avoid unnecessary execution of alternate printing or an error or a paper jam which might be caused by alternate printing.

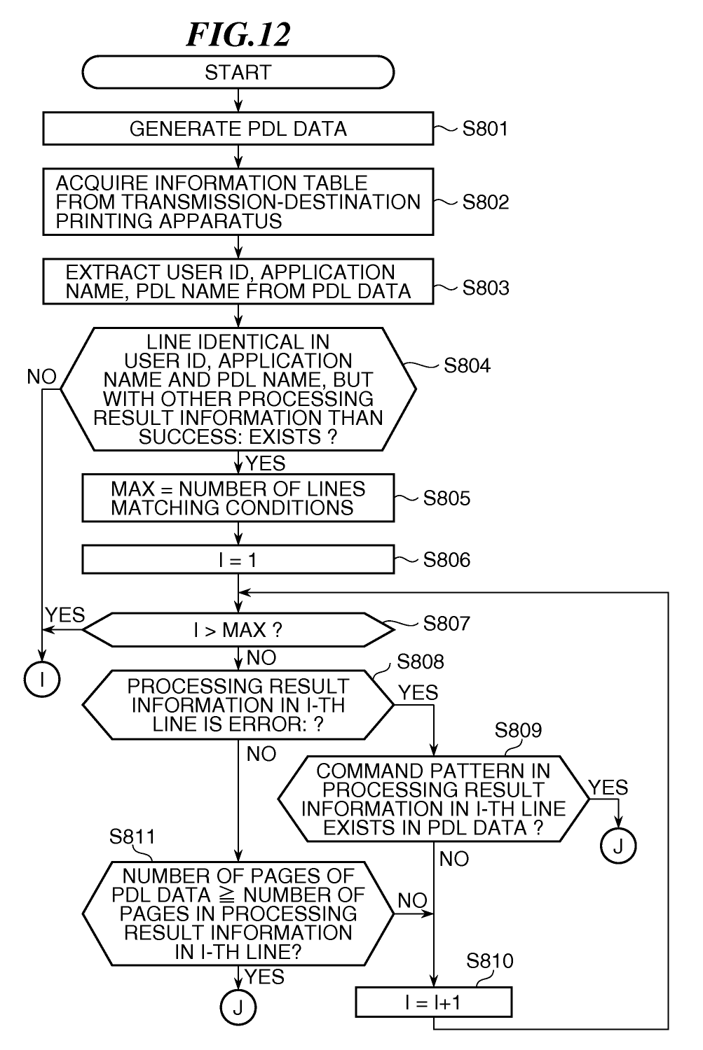

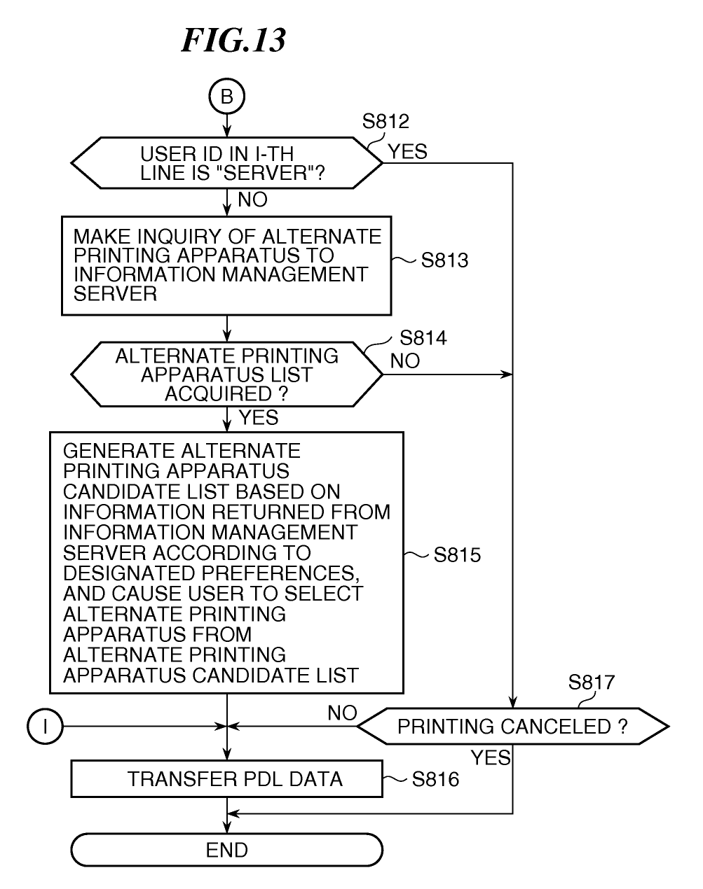

Next, a printing system according to a second embodiment of the present invention will be described with reference to FIGS. 12 and 13. It should be noted that components and elements corresponding to those in the first embodiment are denoted by the same reference numerals.

FIGS. 12 and 13 are a flowchart of a print data transmission process for transmitting PDL data from the host PC 102 to a printing apparatus. The print data transmission process in FIGS. 12 and 13 is executed by the printer driver controlled by the CPU 901, after a control program stored in the ROM 903, the HDD 909 or the like of the host PC 102 is loaded in the RAM 902.

In the present embodiment, part of the processing to be executed by each printing apparatus in the above-described first embodiment is carried out by the printer driver of the host PC 102.

The printer driver is stored in the HDD 909 of the host PC 102, and generates PDL data in response to an instruction from an application program stored in the HDD 909. The PDL data generated by the printer driver is transferred to an alternate printing apparatus via the network interface 904.

First, when a printing process is executed by a desired application stored in the host PC 102, processing by the printer driver is started, and the print data transmission process proceeds to a step S801 in FIG. 12.

In the step S801, the printer driver generates PDL data based on a drawing command sent from the application, and the process proceeds to a step S802.

In the step S802, the printer driver acquires the information table 200 from the printing apparatus 105 as a PDL data transmission destination, and the process proceeds to a step S803. In the step S803, the printer driver extracts a user ID, an application name, and a PDL name from the PDL data generated in the step S801, and the process proceeds to a step S804.

In the step S804, the printer driver determines whether or not the information table 200 acquired in the step S802 contains a line including the same user ID, application name, and PDL name as those extracted in the step S803 and processing result information other than “SUCCESS:”. If the printer driver determines that the information table 200 contains such a line, the process proceeds to a step S805. On the other hand, if the information table 200 contains no such line, the process proceeds to a step S816 in FIG. 13, wherein the printer driver sends the generated PDL data to the printing apparatus 105, followed by terminating the present process.

In the step S805, the printer driver sets the number of lines matching the conditions to the variable MAX, and the process proceeds to a step S806.

In the step S806, the printer driver initializes its counter variable I to 1, and the process proceeds to a step S807.

In the step S807, the printer driver determines whether or not the value of the counter variable I exceeds the value of the variable MAX. If the value of the counter variable I is more than the value of the variable MAX, the process proceeds to the step S816, wherein the printer driver sends the generated PDL data to the printing apparatus 105, followed by terminating the present process. If the value of the counter variable I is not more than that of the variable MAX as in the case of immediately after the initialization of the variable I, the process proceeds to a step S808.

In the step S808, the printer driver determines whether or not the processing result status in the I-th line of all the lines matching the above-mentioned conditions in the step S804 of the information table 200 is “ERROR:”. If the processing result status is not “ERROR:”, the process proceeds to a step S811, whereas if the processing result status is “ERROR:”, the process proceeds to a step S809.

In the step S809, the printer driver determines whether or not the generated PDL data contains a command pattern set forth in the processing result status in the I-th line of all the lines matching the above-mentioned conditions in the step S804 of the information table 200. If the generated PDL data does not contain such a command pattern, the process proceeds to a step S810, wherein the printer driver increments the value of the counter variable I by 1, and then the process returns to the step S807. On the other hand, if the PDL data contains such a command pattern, the process proceeds to a step S812 in FIG. 13.

In the step S811, the printer driver determines whether the total number of pages of the generated PDL data is not less than the number of pages set forth in the processing result status in the I-th line of all the lines matching the above-mentioned conditions in the step S804 of the information table 200. If the total number of pages of the PDL data is less than the number of pages in the processing result status, the process proceeds to the step S810, wherein the printer driver increments the value of the counter variable I by 1, and then the process returns to the step S807. On the other hand, if the total number of pages of the PDL data is not less than the number of pages set forth in the processing result status, the process proceeds to the step S812 in FIG. 13.

Referring to FIG. 13, in the step S812, the printer driver determines whether or not a user ID set forth in the I-th line of all the lines matching the above-mentioned conditions in the step S804 of the information table 200 is “Server”. If the user ID is “Server”, it means that the associated PDL data has caused an error or a paper jam in all the printing apparatuses managed by the information management server 101. Therefore, if the user ID is “Server”, the process proceeds to a step S817, whereas if not, the process proceeds to a step S813.

In the step S817, the printer driver determines whether or not the printing process is canceled e.g. by user operation in the host PC 102. If the printing process is canceled, the printer driver terminates the present process, whereas if not, the process proceeds to the step S816, wherein the printer driver sends the generated PDL data to the printing apparatus 105, followed by terminating the present process.

In the step S813, the printer driver makes an inquiry of an alternate printing apparatus to the information management server 101, and the process proceeds to a step S814. To make an inquiry of an alternate printing apparatus to the step S813, the printer driver sends contents of the items of a line matching the conditions in the step S804 and the condition in the step S809 or S811 of the information table 200 except the line number and the printing apparatus ID of a printing apparatus to which the generated PDL data is to be sent, to the information management server 101. It should be noted that a process executed by the information management server 101 having received the inquiry of an alternate printing apparatus from the printer driver of the host PC 102 is the same as the process in the first embodiment (see FIGS. 9 and 10).

(Selection of Alternate Printing Apparatus)

In the step S814, the printer driver determines whether or not the alternate printing apparatus list 503 (see FIG. 11D) has been acquired from the information management server 101. If the alternate printing apparatus list 503 has been acquired, the process proceeds to a step S815, whereas if not, the process proceeds to the step S817.

In the step S815, the printer driver acquires from the printing apparatus 105 information on preferences designated on the preference designation page 600 shown in FIG. 7, and causes the image display device 906 to display the alternate printing apparatus designation dialog 700 shown in FIG. 8, according to the preference information.

On the preference designation page 600, there are designated respective definitions of printing apparatuses to be displayed as alternate printing apparatus candidates in the alternate printing apparatus designation dialog 700, processing to be executed when there is no alternate printing apparatus candidate, and a number of times of successful processing required for ensuring a “HIGH” degree of reliability of a printing apparatus that ever successfully performed processing of PDL data. In the illustrated example, designation performed on the preference designation page 600 is as follows: All items of definitions of alternate printing apparatus candidates to be displayed are selected; “cause selection between printing and canceling” is selected as processing to be executed when there is no alternate printing apparatus candidate; and “10” is designated as the number of times of successful processing required for ensuring the “HIGH” degree of reliability.

The alternate printing apparatus designation dialog 700 illustrated in FIG. 8 shows the example of the list of alternate printing apparatuses displayed based on items designated on the preference designation page 600 and the alternate printing apparatus list 503.

The preference designation page 600 is displayed on the image display device 906 of the host PC 102, and the administrator of each printing apparatus designates desired items using the external input device 908, such as a pointing device. The alternate printing apparatus designation dialog 700 is displayed on the image display device 906 of the host PC 102, and the user of a host PC that issued PDL data as a print job determines a processing method.

Referring to the alternate printing apparatus list 503 shown FIG. 11D, a degree of reliability associated with Printing Apparatus 4 (corresponding to the printing apparatus 108 in FIG. 1) of line number 2 is “SUCCESS”, but the number of times of successful processing of the same is “3”, which means that the number of times of successful processing has not reached the number ensuring the “HIGH” reliability degree. For this reason, in the alternate printing apparatus designation dialog 700 shown in FIG. 8, the degree of reliability of Printer 02 corresponding to Printing Apparatus 4 of line number 2 in FIG. 11D is displayed as “MEDIUM”. When the degree of reliability in the alternate printing apparatus list 503 is “UNKNOWN” or “DOUBTFUL”, the degree of reliability in the alternate printing apparatus designation dialog 700 is displayed as “LOW”.

Then, in the step S815, the user selects an alternate printing apparatus from the list in the alternate printing apparatus designation dialog 700, using the external input device 908, such as a pointing device, and presses the print button, and the process proceeds to the step S816.

In the step S816, the printer driver transfers the PDL data to the alternate printing apparatus selected in the step S815, followed by terminating the present process. It should be noted that when the cancel button on the alternate printing apparatus designation dialog 700 is pressed in the step S815, the printer driver stops printing, followed by terminating the present process.

As described above, according to the present embodiment, part of the processing executed by a printing apparatus is carried out by the printer driver of the host PC 102, so that it is possible to reduce the load applied to the printing apparatus and the network. The other configuration and advantageous effects of the present embodiment are the same as those of the first embodiment.

It should be noted that the present invention is not limited to the above-described embodiments, but it can be practiced in various forms, without departing from the spirit and scope thereof.

For example, the description in the above-described embodiments is given on the printing apparatus 105, but the same applies to the printing apparatuses 106, 107, and 108.

Further, although in the above-described embodiments, the information on a result of processing of PDL data processed by a printing apparatus is managed by the information management server 101 separately or independently provided, one of the printing apparatuses 105 to 108 may be equipped with a server function similar to that of the information management server 101. In this case, the associated processing programs are stored e.g. in the ROM 1003 of the printing apparatus.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No 2008-311140, filed Dec. 5, 2008 which is hereby incorporated by reference herein in its entirety.

What is claimed is:

1. A printing system including a plurality of printing apparatuses, and a server for managing the printing apparatuses,
wherein the printing apparatus comprises:
a storing unit configured to store processing result information on print data;
a notification unit configured to notify the processing result information to the server;
an extraction unit configured to extract identification information from print data transmitted from an information processing apparatus;
a determination unit configured to determine, based on the identification information and the processing result information, whether or not it is possible to normally print the print data transmitted from the information processing apparatus;
an inquiry unit configured to be operable when said determination unit determines that it is not possible to normally print the print data, to make an inquiry of an alternate printing apparatus which is capable of normally printing the print data transmitted from the information processing apparatus, to the server; and
a transmission unit configured to transmit the print data transmitted from the information processing apparatus to the alternate printing apparatus, based on information for identifying an alternate printing apparatus as a transfer destination, which is transmitted from the server in response to the inquiry made by said inquiry unit, and
wherein the server comprises:
a management unit configured to manage the processing result information on the print data notified from the printing apparatus by said notification unit;
a determining unit configured to determine the information for identifying an alternate printing apparatus as a transfer destination, based on the processing result information managed by said management unit, in response to the inquiry from the printing apparatus made by said inquiry unit; and
a returning unit configured to return the information for identifying an alternate printing apparatus as a transfer destination, which is determined by said determining unit, to the printing apparatus that made the inquiry.

2. A printing system according to claim 1, wherein the information processing apparatus includes an acquisition unit configured to acquire from the printing apparatus preference information for use in displaying a list of alternate printing apparatuses as respective transfer destinations on an image display device and display the acquired preference information on the image display device,
a display unit configured to display on the image display device a selecting screen showing the list of alternate printing apparatuses as respective transfer destinations for a user to select the alternate printing apparatus as the transfer destination, based on designated contents of the preference information displayed on the image display device, and
a delivery unit configured to deliver information identifying the alternate printing apparatus as the transfer destination selected on the selecting screen to the printing apparatus, and
wherein said transmission unit of the printing apparatus transmits the print data transmitted from the information processing apparatus to the alternate printing apparatus based on the information identifying the alternate printing apparatus, which is transmitted from the information processing apparatus.

3. A printing system according to claim 1, wherein the server is a printing apparatus equipped with a server function.

4. A printing apparatus which is capable of communicating with an information processing apparatus, at least one other printing apparatus, and a server for managing a plurality of printing apparatuses, comprising:
a storing unit configured to store processing result information on print data;
a notification unit configured to notify the processing result information to the server;
an extraction unit configured to extract identification information from print data transmitted from the information processing apparatus;
a determination unit configured to determine, based on the identification information and the processing result information stored in said storing unit, whether or not it is possible to normally print the print data transmitted from the information processing apparatus;
an inquiry unit configured to be operable when said determination unit determines that it is not possible to normally print the print data, to make an inquiry of an alternate printing apparatus which is capable of normally printing the print data transmitted from the information processing apparatus, to the server; and
a transmission unit configured to transmit the print data transmitted from the information processing apparatus to the alternate printing apparatus, based on information for identifying an alternate printing apparatus, which is transmitted from the server in response to the inquiry made by said inquiry unit.

5. A method of controlling a printing apparatus which is capable of communicating with an information processing apparatus, at least one other printing apparatus, and a server for managing a plurality of printing apparatuses, comprising:
storing processing result information on print data in a storing unit;
notifying the processing result information to the server;
extracting identification information from print data transmitted from the information processing apparatus;
determining, based on the identification information and the processing result information stored in the storing unit, whether or not it is possible to normally print the print data transmitted from the information processing apparatus;
making an inquiry of an alternate printing apparatus which is capable of normally printing the print data transmitted from the information processing apparatus, to the server, when said determining determines that it is not possible to normally print the print data; and
transmitting the print data transmitted from the information processing apparatus to the alternate printing apparatus, based on the information for identifying an alternate printing apparatus, which is transmitted from the server in response to the inquiry.
